(19) United States
(12) Patent Application Publication
(10) Pub. No.: US 2015/0159399 A1
(43) Pub. Date: Jun. 11, 2015

(54) PUSH/PULL LATCH WITH FACETED PADDLE HANDLE

(71) Applicant: ARCHITECTURAL BUILDERS HARDWARE MFG., INC., Itasca, IL (US)

(72) Inventors: Ankit Kirti Shah, Chicago, IL (US); Kirti Shah, South Barrington, IL (US); Darryl Devine, Huntley, IL (US)

(21) Appl. No.: 14/562,189

(22) Filed: Dec. 5, 2014

Related U.S. Application Data
(60) Provisional application No. 61/912,312, filed on Dec. 5, 2013.

(51) Int. Cl. E05B 7/00

(52) U.S. Cl. CPC E05B 7/00

(57) ABSTRACT

A door handle assembly for use with a door is provided, and includes a cover; and a handle associated with the cover and pivotal relative thereto. The handle has a non planar surface and is configured for actuation from a variety of angles.

### RELATED APPLICATION

The present application claims priority under 35 USC 119(e) from U.S. Ser. No. 61/912,312 filed Dec. 5, 2013.

### BACKGROUND

The present invention relates generally to push/pull type door latch assemblies that include paddle style handles that are selectively positionable in either in up, down, horizontal left or horizontal right configurations. More specifically, the present invention relates to handle configurations of such devices.

Examples of existing push/pull door latch assemblies are described in U.S. Pat. Nos. 6,293,598; 7,258,374; 7,481,607; 6,196,599 and U.S. Pat. No. 5,730,478, and US Patent Publication No. 2013/0076046A1, all commonly assigned to Architectural Builders Hardware Manufacturing, Inc., and hereby incorporated by reference. Such door latch assemblies include, generally, a latching mechanism, at least one handle assembly and at least one cam assembly.

A common problem of conventional push/pull door latches is that they must be actuated by a pushing or pulling force generally perpendicular to a main plane of the paddle handle. This restricts the movements and/or positions of individuals needing to open the doors when their hands are full, or are otherwise unable to actuate the latch.

Such conventional push/pull door latches can also cause discomfort to an individual actuating the door from an approach other than straight toward the door because a body part, e.g., a leg, hip or buttocks, can easily contact an edge of the paddle instead of a face surface. Such edges are shown, for example, in Mussi et al. US D646,548 and US D646,549. In the '548 and '549 design patents, a strong taper in the paddle to a narrow point increases the likelihood of body part-to-edge contact. The relatively large escutcheon/cover on the assembly associated with the paddles also makes body part/edge contact more likely because individuals will naturally attempt to contact the paddle away from the escutcheon. Frequent individual-to-edge contact can reduce lifetime of the latch, as well. With use of legs, hips and buttocks, significant forces can be applied to the latch. The paddles in the '548 and '549 design patents fail to adequately translate forces from individual to edge contact, which can stress the actuating assembly and paddle.

### SUMMARY

Thus, there is a need for a push/pull latch that is actuable by a user from the side of the latch or other non-perpendicular orientation to increase the options available to users of such latches, particularly medical technicians, nurses, doctors and the like, who often need to open such doors using their hips, legs or parts of the body other than hands. This need is met by the present faceted paddle handle for a push/pull latch, which, in one embodiment, features a central planar portion for perpendicular manipulation, as well as at least one and preferably two angled facets on either side of the central planar portion. The angled portions are configured so that edges of the angled portions point at angles toward the respective door. Thus, an actuating surface is presented to the user so that the latch is actuable from the side, or at a greater range of angles relative to perpendicular compared to conventional push/pull latches. Using the present faceted panel, users can actuate the latch by bumping or otherwise impacting the paddle using a side impact.

More specifically, a door handle assembly for use with a door is provided, and includes a cover; and a handle associated with the cover and is pivotal relative thereto. The handle has a non planar surface and is configured for actuation from a variety of angles.

In another embodiment, a door handle assembly for use with a door is provided and includes a cover; and a handle associated with the cover and pivotal relative thereto. The handle having a central portion and a pair of facets each projecting from a lateral side of said central portion at an angle relative to the central portion, the angle selected for facilitating actuation of said handle from a variety of angles.

In still another embodiment, a door handle assembly for use with a door, is provided and includes a cover; and a handle pivotably movable relative to the cover and including a pair of angled facets joined along a common edge, each facet projecting at a designated angle relative to a plane extending from the common edge and being generally transverse to an axis defined by the pivoting action of the handle relative to the cover.

### BRIEF DESCRIPTION OF THE DRAWINGS

FIG. 1 is a top perspective view of the present handle shown mounted on a door;

FIG. 2 is a front elevation of the handle of FIG. 1;

FIG. 3 is a side view of the present handle;

FIG. 4 is a top view of the present handle;

FIG. 5 is a bottom view of the present handle;

FIG. 6 is an exploded perspective view of a suitable door latch mechanism usable with the present handle;

FIG. 7 is a front view of an alternate embodiment of the present handle; and

FIG. 8 is a cross-section taken along the line 8-8 of FIG. 7 and in the direction generally indicated.

### DETAILED DESCRIPTION

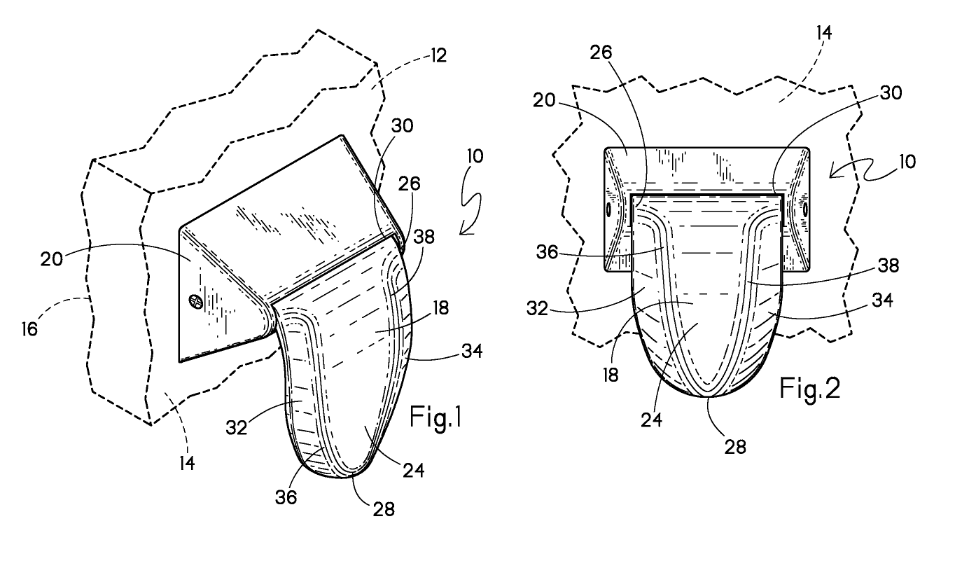

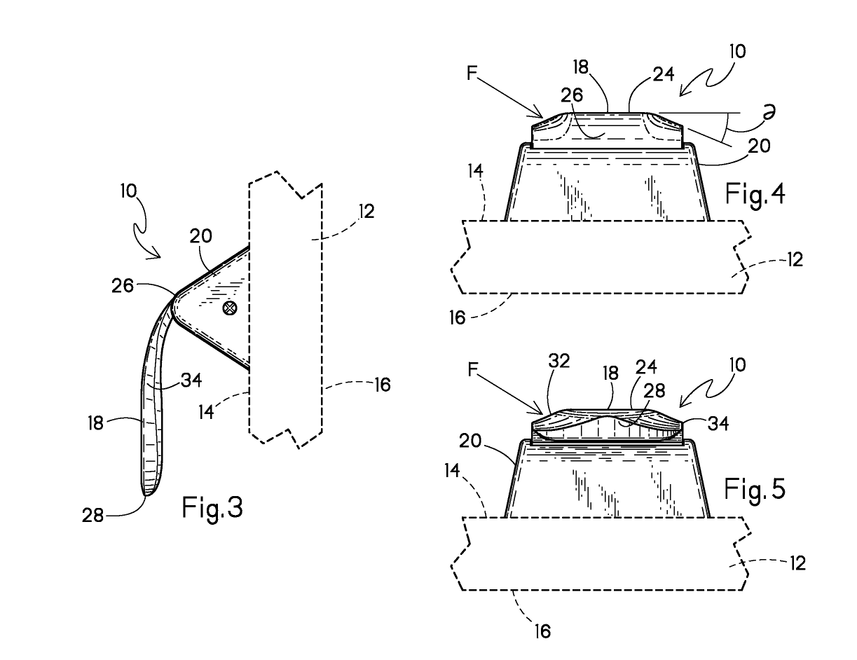

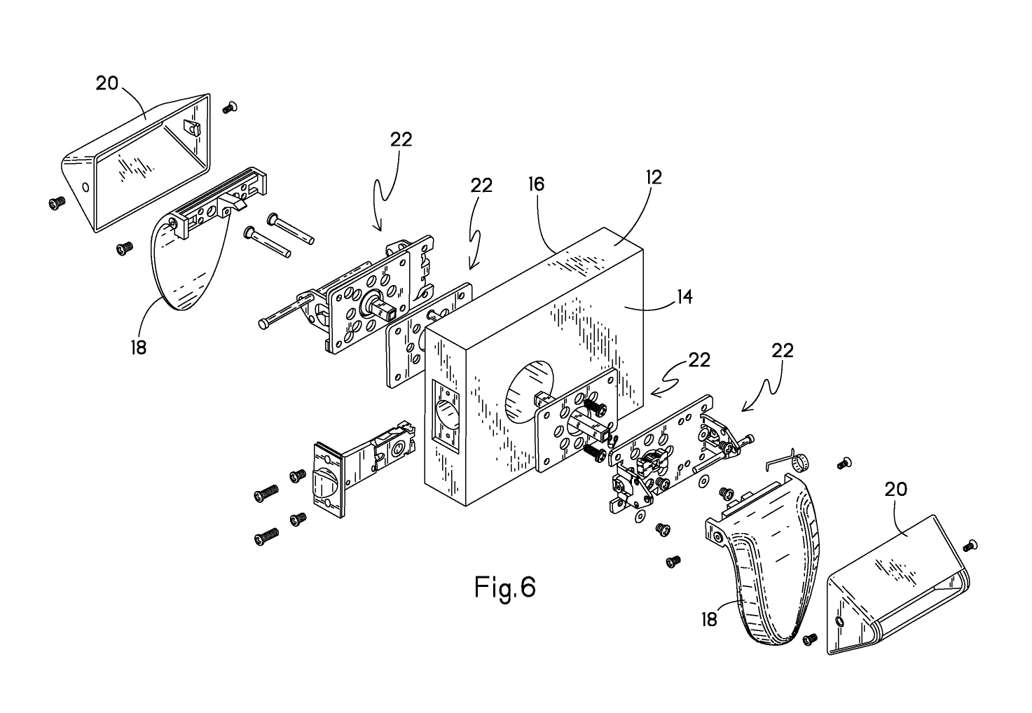

Referring now to FIGS. 1-5, a door latch handle assembly is generally designated 10 and is configured for use with a door 12 (shown in phantom). Typically, an assembly 10 is mounted on each of first and second sides 14, 16 of the door 12, however only one side is shown here. The assembly 10 is provided with a non-planar paddle handle, generally designated 18 and a cover or escutcheon, generally designated 20. The interior mechanism 22 of the handle assembly 10 is shown in FIG. 6 and is described in detail in commonly-assigned U.S. patent application Ser. No. 13/347,433, filed Jan. 10, 2012, published as US 2013/0076046 and incorporated by reference. The internal mechanism 22 is not critical to the operation of the present handle assembly, and any of the mechanisms disclosed in the above-identified latches incorporated by reference, or otherwise known in the art are considered applicable with the present handle assembly 10.

A main feature of the present handle 18 is a generally planar, generally centrally-located portion 24, that extends from a hinge end 26 to a tip 28. The hinge end 26 pivots relative to the cover 20 within a cover slot 30. At least one and preferably two angled facets 32, 34 are disposed on either lateral side 36, 38 of the central portion 24. It is contemplated that the angle of deflection δ of the facets 32, 34 relative to the central portion 24 may vary; however a sufficient angle δ of deflection (FIG. 4) is contemplated such that a force ‘F’ directed on the paddle handle 18 from a side or non-perpendicular direction relative to a plane defined by the central portion 24 will cause or facilitate actuation of the handle, and opening of the latch mechanism 22 included in the handle assembly 10. In the preferred embodiment, the angle δ ranges from 5 to 60°, however other orientations are contemplated.

It will be appreciated that while, in the depicted embodiment, the facets 32, 34 are narrower in width along a vertical axis compared to the central portion 24, such relative dimensions are variable depending on the application. Also, it is preferred that the facets 32, 34 extend from the hinge end 26 to the lower edge or tip 28 of the handle 18; however shorter facets are contemplated, also depending on the application.

Further, in the present handle 18, to accommodate the shape of the facets 32, 34, which also have a slight “banana” shape when viewed from the front (FIG. 1), preferably has a taper towards the tip portion 28. The present handle 18 is made in a single piece, either by casting and polishing, or molding, or other known fabrication techniques.

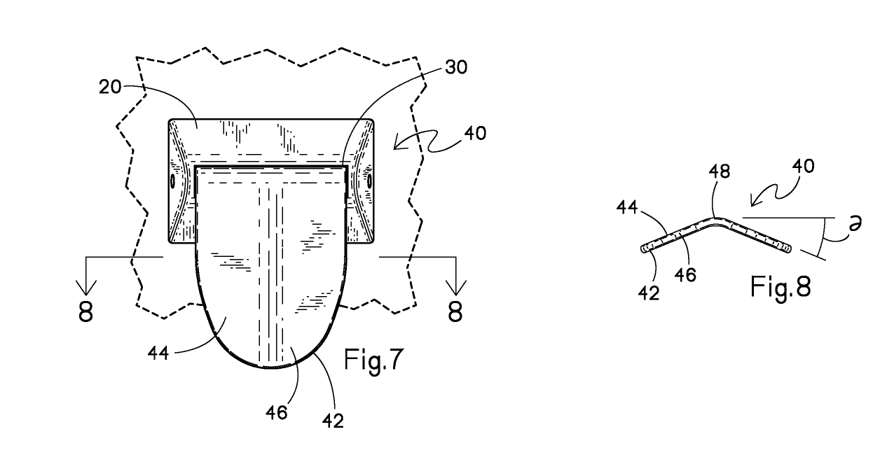

Referring now to FIGS. 7 and 8, an alternate embodiment of the present door latch assembly is depicted and generally designated 40. Shared components with the assembly 10 are indicated with identical reference numbers. It is contemplated that, depending on the application, the relative sizes of the facets 32, 34 and the central portion 24 may vary to the extent that the central portion 24 is relatively small and/or absent. In a handle 42 of the assembly 40, the facets 44, 46 share a common edge 48, which also serves as the central portion and may be radiused or planar, depending on the application. The facets 44, 46 are oriented at a similar angle δ relative to a plane projecting from the common edge 48 as in the handle 18, however other angles are contemplated. The plane described immediately above extends generally transverse to a pivot axis about which the handle pivots at the pivot end 26.

Thus, it will be seen that the present handles 18, 42 provide users with multiple surfaces for actuating the respective latch mechanisms. In this way, the latches are actuated more easily from a variety of directions, and users can more readily employ other body parts to open the latch when the hands are otherwise occupied.

While particular embodiments of the present push/pull latch with faceted handle have been described herein, it will be appreciated by those skilled in the art that changes and modifications may be made without departing from the invention in its broader aspects and as set forth in the following claims.

1. A door handle assembly for use with a door, and comprising:
a cover; and
a handle associated with the cover and pivotal relative thereto,
said handle having a non planar surface and being configured for actuation from a variety of angles.

2. The door handle assembly of claim 1, wherein said handle has a central portion and at least one facet projecting at an angle relative to the central portion.

3. The door handle assembly of claim 2, wherein said at least one facet extends from a hinge end to a tip of said handle.

4. The door handle assembly of claim 2, further including a pair of said facets, one on each side edge of the central portion.

5. The door handle of claim 2, including a pair of facets sharing a common edge, which also serves as the central portion.

6. The door handle of claim 2, wherein said at least one facet defines an angle relative to said central portion in the range of 5 to 60°.

7. The door handle of claim 2, wherein said at least one facet is generally banana-shaped when viewed from the front.

8. The door handle of claim 2, wherein said at least one facet is narrower in width than said central portion.

9. A door handle assembly for use with a door, and comprising:
a cover; and
a handle associated with the cover and pivotal relative thereto, said handle having a central portion and a pair of facets each projecting from a lateral side of said central portion at an angle relative to the central portion, said angle selected for facilitating actuation of said handle from a variety of angles.

10. The handle of claim 9 wherein the angle defined by each said facet is in the range of 5 to 60°.

11. The handle of claim 9 wherein each said facet is narrower in width than said central portion.

12. The handle of claim 9 wherein said angles of actuation are non-perpendicular to a plane defined by said central portion.

13. A door handle assembly for use with a door, and comprising:
a cover; and
a handle pivotably movable relative to said cover and including a pair of angled facets joined along a common edge, each said facet projecting at a designated angle relative to a plane extending from said common edge and being generally transverse to an axis defined by said pivoting action of said handle relative to said cover.

14. The handle of claim 13 wherein each said facet projects at an angle from said common edge in the range of 5 to 60°.
